(19) United States
(12) Patent Application Publication
(10) Pub. No.: US 2022/0016700 A1
(43) Pub. Date: Jan. 20, 2022

(54) TWO-STAGE SINTERING FURNACE AND METHODS OF OPERATING THEREOF

(71) Applicant: Desktop Metal, Inc., Burlington, MA (US)

(72) Inventors: Nathan Woodard, Medford, MA (US); Richard Remo Fontana, Cape Elizabeth, MA (US); Robert Edward Weiss, San Francisco, CA (US)

(73) Assignee: Desktop Metal, Inc., Burlington, MA (US)

(21) Appl. No.: 17/436,790

(22) PCT Filed: Mar. 13, 2020
(86) PCT No.: PCT/US2020/022725

§ 371 Date: Sep. 7, 2021

Related U.S. Application Data
(60) Provisional application No. 62/819,285, filed on Mar. 15, 2019.

(51) Int. Cl. B22F 3/00; B22F 3/10; F27B 9/14; F27B 17/00

(52) U.S. Cl. CPC B22F 3/003; B22F 3/1021; F27B 2017/0091; F27B 17/0016; F27B 9/14

(57) ABSTRACT

A sintering and debinding system includes a debinding chamber configured to switch between an open state and a closed state, the open state being configured to permit receipt or removal of at least one part within or from the debinding chamber and a sintering chamber operably connected to the debinding chamber and being vertically positioned above or below the debinding chamber. The sintering system also includes a shelf structure configured to receive the at least one part, the shelf structure being movable between the debinding chamber and the sintering chamber and a gate valve configured to switch between an open state and a closed state, the gate valve being configured to selectively permit or block fluid communication between the debinding chamber and the sintering chamber. The gate valve is configured such that: when the gate valve is in an open state, fluid communication between the debinding chamber and the sintering chamber is permitted and the shelf structure is movable between the debinding chamber and the sintering chamber. The gate valve is further configured such that, when the gate valve is in the closed state, fluid communication between the debinding chamber and sintering chamber is restricted, and at least one of: (i) movement of the shelf structure between the debinding chamber and the sintering chamber is restricted or (ii) the debinding chamber is configured to permit receipt within and removal of the at least one part from the debinding chamber.

### CROSS-REFERENCE TO RELATED APPLICATION

This application claims the benefit of priority of U.S. Provisional Application No. 62/819,285, filed Mar. 15, 2019, the entirety of which is incorporated by reference into this application.

### TECHNICAL FIELD

Various aspects of the present invention relate generally to, among other things, sintering furnaces and methods, and, in particular, to furnaces and methods for sintering powder metal 3D printed parts (components) fabricated using additive manufacturing.

### BACKGROUND

In additive manufacturing, such as 3D printing, a final part may be produced from metal particles. These particles may be joined together by a binder material in a so-called “green” state. The fabrication process may include removing the binder material in one or more debinding processes. For example, in a two-step debinding process, a first (e.g., primary) binder may be removed with a liquid debinder, leaving the part in a so-called “brown” state where the part includes a second (e.g., secondary) binder that may be removed by thermal debinding. After thermal debinding, which may thermally volatize the second binder, the part may be sintered to form a solid (e.g., metallic) part.

Debinding and sintering may be performed in an atmosphere-controlled furnace such as a vacuum sintering furnace. Vacuum sintering furnaces may require atmospheres having relatively high levels of purity for example, parts per million (ppm) contamination, or even parts per billion (ppb), during sintering. Increased purity or cleanliness of the atmosphere within the furnace may generally be desirable and, for at least metal parts, may result in final parts with relatively higher quality (e.g., parts with higher density, such as greater than 95% density, or greater than 98% density), and/or parts manufactured with good control over carbon content (e.g., carbon content of hundredths of a percent). Additionally, it may be desirable to limit oxygen content to less than about 1% in at least some materials. However, quality metrics may vary significantly depending on material and application. Additionally, cleaner furnaces may have advantageous affects when sintering materials other than metal.

Vacuum furnaces may include heaters and insulation contained within a vacuum chamber. For example, FIG. 1 depicts a vacuum furnace 10 having insulation 12 (e.g., furnace insulation), extending along inner walls of a vacuum chamber or housing 14, as well as heating elements 16 (furnace heaters) arranged inwardly of the insulation 12. Examples of insulation 12 include: a porous and/or fibrous insulation, such as ceramic fiber, graphite fiber, or both, or a multilayer heat shield, such as layered molybdenum foil. While these materials may tend to reduce the power requirements of the furnace, the use of more insulation may tend to result in a dirtier atmosphere. This is especially true for porous insulation.

One strategy to increase cleanliness within the atmosphere of a furnace, such as furnace 10, is to employ water cooling 18 on the vacuum housing 14 to reduce the amount of insulation 12 required. When designing a furnace to achieve a desired sintering temperature, once the minimum thickness of insulation 12 is established (e.g., to allow furnace 10 operate just below the threshold for damage to the housing 14), heating power may be determined based on the quantity of power required to reach the desired sintering temperatures. However, this approach may tend to increase design costs (e.g., due to the increased costs associated with the waster cooling system) and may require high amounts of power.

As illustrated in FIG. 1, furnace 10 may include high-temperature furnace heaters 16 configured to receive electrical power from a power supply 22 controlled by a furnace system controller 24 (control signals in FIGS. 1-3 are represented by “C”). In at least some furnaces, a high-temperature thermal insulation arrangement 12 may be required to keep power consumption within practical limits and to avoid excessive overheating of the system (e.g., furnace parts) and/or the surrounding room. Even with high-performance insulation 12, the maximum achievable temperature may be limited by a combination of factors including at least: (i) the surface area of the inner hot face of insulation 12 (e.g., more surface area requires more power); (ii) the type and quality of insulation 12; (iii) the thickness of insulation 12; (iv) the overall condition of insulation 12 with respect to aging and wear; and/or (v) the vacuum pressure. In general, larger furnaces require more power, as power requirements increase in proportion with an increase in the size of the inner hot face of the insulation 12.

While furnaces with refractory metal insulation may facilitate a high-purity or less-contaminated processing environment as compared to furnaces with other forms of insulation, such furnaces may be relatively costly. For example, the raw refractory metal material itself may be costly, the furnace may have relatively high-power requirements, and frequent maintenance may be required, including replacement of the refractory metal insulation, which tends to degrade relatively rapidly. Furnaces with types of insulation other than refractory metals materials may be less costly, but may tend to experience increased contamination from the insulation or from the insulation interacting with the environment within the furnace, in particular during operational steps including loading, unloading, standby, and when the furnace is out of service. Fiber insulation, such as lightweight graphite fiber insulation (or “graphite insulation”) or ceramic fiber insulation (or “ceramic insulation”), may be arranged inside of a vacuum furnace chamber. However, each of these insulation technologies may each have associated disadvantages. For example, each type of insulation may, to varying degrees, tend to absorb vapor, binder, or other contaminants, and may release contaminants during sintering.

FIGS. 1-3 illustrate gas circulation in vacuum furnace 10 during vacuum baking. Furnace 10 may be sealed so that, during heat treating and/or sintering processes, desired gases or mixtures (e.g., processing gas 20) are introduced in the sealed chamber 14. Vacuum sintering furnaces may utilize processing gas 20 while pumping with a vacuum pump 26 (FIG. 1) out of the furnace, to create an outlet gas flow 28 and to control the atmosphere to which parts 30 (e.g., traditionally manufactured parts, 3D printed parts, parts produced using additive manufacturing, etc.) arranged in the furnace are exposed to. The pressure in the furnace, and in particular in the hot zone volume that is arranged for receiving the parts 30, may be monitored, for example, by a vacuum pressure gauge 32 (FIG. 2) and may be controlled by balancing the inlet flow rate (regulated process gas 20, FIG. 2) with the outlet gas flow 28. Outlet gas flow 28 may be controlled by toggling a controllable valve, by controlling an adjustable valve and/or by changing the pumping rate of pump 26. As represented in FIG. 1, vacuum valves may be controlled by a furnace system controller 24. Inlet gas flow 20 may be controllably varied by way of a mass flow controller (MFC) 34 controlled by the furnace system controller 24. There are many systems and methods for overall furnace system control, including PLC's, computers, etc. Controllers may range in complexity from simple open loop feedback and/or state machines to custom microchip controlled embedded controllers. In some embodiments, it may be possible to connect controllers to computers through standard serial or parallel buses, ethernet, and WIFI, or any other suitable wired or wireless connection.

It should be understood that parts 30 themselves may outgas (in particular, during debinding), as may the furnace system, including insulation 12 and the inside walls of the vacuum chamber 14. This outgassing may affect pressure and control over the pressure. The balancing performed by controller 24 may be influenced by and may be responsive to outgassing from the parts. As illustrated in FIGS. 2 and 3, the regulated process gas 20 may be directed using an internal process gas feed such that the process gas flows over parts 30 that are arranged in the hot zone volume of furnace 12 (e.g., on a shelf structure 36).

There exists a need for a debinding and sintering system that allows achieving debinding and sintering of a metal part in a very clean atmosphere at a reduced cost. In particular, there is a need for improved debinding and/or sintering furnaces to improve the quality of the produced parts, reduce power consumption, and provide a cleaner atmosphere.

### SUMMARY

Examples of the present disclosure relate to, among other things, systems and methods for debinding and/or sintering furnaces, in particular for sintering parts, e.g., powder metal 3D printed parts (also referred to as components) fabricated using additive manufacturing. Each of the examples disclosed herein may include one or more of the features described in connection with any of the other disclosed examples.

In at least some embodiments, a low-power powder metal sintering system may include: a sealable sintering furnace having walls that may be covered inwardly by a sintering insulation layer, an inward face of the sintering insulation layer defining a sintering hot zone volume; and/or sealable debinding oven that may include a debinding hot zone volume. Further, the sealable sintering furnace may include a controllable gate valve. The gate valve may be arranged such that (i) in an open position the gate valve is configured to allow movement of a shelf structure that may be capable of holding a 3D printed part, for example, from the debinding hot zone volume to the sintering hot zone volume and reciprocally; and (ii) in a closed position the gate valve is configured to restrict gaseous communication between the outside and the inside of the sintering furnace. Further, the sintering furnace may include a heating element in the sintering hot zone volume, the sintering insulation layer and the heating element may be arranged for bringing a 3D printed part arranged in the sintering hot zone volume at a sintering temperature in excess of 900 degrees centigrade using no more than 10 kW steady state of holding power per square meter of the sintering hot zone volume. Further still, the debinding oven may be arranged for bringing a 3D printed part arranged in the debinding hot zone volume at a debinding temperature in excess of 100 degrees centigrade. The debinding oven may have a sealable opening arranged such that (i) in an open position, the sealable opening is configured to allow loading from the outside of the system a 3D printed part on the shelf structure when the shelf structure is, for example, held outside the sintering hot zone volume; and (ii) in a closed position the sealable opening may restrict gaseous communication between the outside and the inside of the debinding oven. Following the above, the gate valve may be in the closed position when the sealable opening is, for example, in the open position, such that the debinding oven may operate as a load lock chamber isolating the sintering furnace from exposure to atmospheric contaminants.

In at least some embodiments, the debinding oven may be arranged above the sintering furnace, and/or the gate valve may be arranged vertically between the debinding hot zone volume and the sintering hot zone volume.

In at least some embodiments, the debinding oven may be arranged above the sintering furnace such that, for example, the gate valve may be arranged vertically between the debinding hot zone volume and the sintering hot zone volume. In at least some instances, the sintering insulation layer may include a sintering insulation opening that may allow moving the shelf structure into the sintering hot zone volume. Further, in at least some embodiments, a top portion of the shelf structure may be, for example, covered with a top insulation having dimensions that match those of the sintering insulation layer opening such that the top insulation may be aligned with the sintering insulation layer and/or at least partially close the sintering insulation layer opening when the shelf structure is, for example, in the sintering hot zone volume.

In at least some embodiments, the sintering insulation layer may include a sintering insulation opening for allowing the shelf structure to pass through the opened gate valve and/or a sintering insulation latch arranged to controllably open or close the sintering insulation opening with a mobile sintering insulation.

In at least some embodiments, the sintering insulation latch may be actuated using a rotational or linear motion mechanism arranged for operating at low pressure. Further, in at least some instances, the sintering insulation latch may include insulation plates that may be controllably actuated to pivot along axes normal to an axis of the sintering insulation opening.

In at least some embodiments, the debinding oven and the sintering furnace, including the gate valve, may be enclosed within a housing, the gate valve may be arranged to remain contained within the housing when the gate valve is, for example, in its open and closed positions.

In at least some embodiments, the sintering furnace may be arranged to operate at a sintering pressure within a predetermined range of low pressures, for example, such as below one atmosphere and/or the walls of the sintering furnace and the closed gate valve may form a vacuum chamber.

In at least some embodiments, the debinding oven may be arranged to controllably bring the debinding hot zone volume from atmospheric pressure to a predetermined debinding low pressure, and reciprocally.

In at least some embodiments, the debinding oven may be arranged such that when the sealable opening and the gate valve are, for example, in closed position, vacuum bake out is possible in the debinding hot zone volume and/or for a 3D printed part on the shelf structure in the debinding hot zone volume.

In at least some embodiments, the sintering system may be arranged, for example, to bring the sintering furnace to the sintering temperature when the gate valve is, for example, in the closed position and/or to a predetermined lower sintering furnace idle temperature sufficient for preventing the condensation of pollutants in the sintering furnace prior to opening the gate valve.

In at least some embodiments, the sintering system may include a debinding oven atmosphere control manifold configured to be coupled to the debinding oven and/or arranged for implementing at least one of the following operations: (i) displacing atmospheric air out of the debinding hot zone volume by introducing a predetermined gas such as a purified inert gas, into the debinding hot zone volume; (ii) bringing the debinding hot zone volume to a predetermined debinding low pressure by pumping out the debinding oven; (iii) maintaining the predetermined debinding low pressure in the debinding hot zone volume while gas is, for example, emitted by a 3D printed part in the debinding hot zone volume; (iv) maintaining the predetermined debinding low pressure in the debinding hot zone volume while gas is, for example, emitted by a 3D printed part in the debinding hot zone volume and while injecting a processing gas in the debinding oven; (v) bringing the debinding hot zone volume to a room pressure; and/or (vi) bringing the debinding hot zone volume to a room pressure while flushing contaminants out of the debinding oven.

In at least some embodiments, the sintering system may include a sintering furnace atmosphere control manifold configured to be sealingly coupled to the sintering furnace and/or arranged for implementing at least one of the following operations: (i) bringing the sintering hot zone volume to a sintering pressure within a predetermined range of low pressures by pumping gas out of the sintering furnace; (ii) introducing in the sintering furnace a processing gas that may include in majority an inert gas and also that may include hydrogen, such as including 98% of argon or nitrogen and 2% of hydrogen; (iii) maintaining the sintering pressure within the predetermined range of low pressures in the sintering hot zone volume while injecting a reducing atmosphere in the sintering furnace, for example such that the reducing atmosphere falls over working parts arranged on the shelf structure; (iv) maintaining the sintering pressure within the predetermined range of low pressures in the sintering hot zone volume while injecting a processing gas in the sintering furnace, for example, such that the processing gas falls over working parts arranged on the shelf structure; and/or bringing the sintering hot zone volume to a room pressure.

In at least some embodiments, the sintering system may include a manipulator that may be arranged for moving the shelf structure between the debinding hot zone volume and the sintering hot zone volume when the gate valve is, for example, in the open position. In at least some instances, the manipulator may include: (i) a lock portion arranged for controllably engaging with and disengaging from the shelf structure and/or (ii) an actuator that may be located out of the sintering furnace and that may be arranged for moving the lock portion between the debinding hot zone volume and the sintering hot zone volume. In at least some embodiments, the shelf structure may be rested in the sintering hot zone volume on a seat and/or the manipulator may be arranged such that when the gate valve is, for example, in the open position and the shelf structure is, for example, in the debinding hot zone volume, the shelf structure to the seat may be moved, disengaging the lock portion from the shelf structure and/or the lock portion may be moved out of the sintering hot zone volume such that the gate valve may be brought to the closed position.

In at least some embodiments, the debinding oven may be sealingly attached to the sintering furnace and/or the debinding oven may include a door for opening and closing the sealable opening.

In at least some embodiments, the debinding oven may form a bell jar structure. Further, the opening of the bell jar structure may form the sealable opening and may be provided for cooperating with a seal seat arranged on a top periphery of the gate valve.

In at least some embodiments, the debinding oven may include a sealable chamber that may have walls covered inwardly by a debinding insulation layer and/or an inward face of the debinding insulation layer that may define the debinding hot zone volume. Further, in at least some instances, (i) the debinding oven may be arranged above the sintering furnace such that the gate valve may be arranged vertically between the debinding hot zone volume and the sintering hot zone volume; (ii) the debinding insulation layer may include a debinding insulation opening that may allow moving the shelf structure into the debinding hot zone volume; and/or (iii) wherein a bottom portion of the shelf structure may be covered with a bottom insulation that may have dimensions that substantially match those of the debinding insulation opening and/or the bottom insulation may be arranged such that it may be aligned with the debinding insulation layer and at least partly close the debinding insulation opening when the shelf structure is, for example, in the debinding hot zone volume.

In at least some embodiments, the debinding oven may include a sealable chamber having walls covered outwardly by a debinding insulation layer and/or an inward face of the walls of the debinding oven may define the debinding hot zone volume.

In at least some embodiments, the debinding oven may include a sealable chamber having walls covered inwardly or outwardly by a debinding insulation layer. Further, the debinding insulation may have a debinding insulation opening, for example, for allowing the shelf structure to pass through the opened gate valve and/or a debinding insulation latch that may be arranged to controllably open or close the debinding insulation opening with an insulation. In at least some instances, the debinding insulation latch may include insulation plates that may be controllably actuated to slide along a plane normal to an axis of the debinding insulation opening.

In at least some embodiments, a low power powder metal sintering system may include: (i) a sealable sintering furnace that may have walls covered inwardly by a sintering insulation layer and/or an inward face of the sintering insulation layer that may define a sintering hot zone volume; (ii) a sealable debinding oven that may include a debinding hot zone volume; and/or (iii) the sealable sintering furnace may have a controllably actuatable gate valve. Further, the gate valve may be arranged such that (a) when in an open position a shelf structure may be moved that may be capable of holding a 3D printed part from the debinding hot zone volume to the sintering hot zone volume and reciprocally and/or (b) when in a closed position gaseous communication between the outside and the inside of the sintering furnace may be restricted. Further still, the sintering furnace may include at least one heating element in the sintering hot zone volume, the sintering insulation layer and/or the heating element may be arranged for bringing a 3D printed part arranged in the sintering hot zone volume at a sintering temperature in excess of 900 degrees centigrade using no more than 8 kW steady state of holding power per cubic foot of the sintering hot zone volume. In at least some instances, the debinding oven may be arranged for bringing a 3D printed part arranged in the debinding hot zone volume at a debinding temperature in excess of 100 degrees centigrade and/or the debinding oven may have a sealable opening arranged such that (i) in an open position, it is configured to load from the outside of the system a 3D printed part on the shelf structure when the shelf structure is, for example, held outside the sintering hot zone volume and/or (ii) when in a closed position gaseous communication between the outside and the inside of the debinding oven may be restricted. Further, the gate valve may be in the closed position when the sealable opening is, for example, in the open position such that the debinding oven may, for example, operate as a load lock chamber isolating the sintering furnace from exposure to atmospheric contaminants.

In at least some embodiments, systems disclosed herein may be used for maintaining the sintering furnace at a sintering pressure within a predetermined range of low pressures and at one of the sintering temperature and a sintering furnace idle temperature and/or using the debinding oven as a load lock to the sintering furnace with the sintering furnace at the sintering furnace idle temperature.

In at least some embodiments, using the debinding oven as a load lock to the sintering furnace with the sintering furnace at the sintering furnace idle temperature may be configured such that (i) when the gate valve in the closed position and the shelf structure in the debinding hot zone volume the sealable opening of the debinding oven may be opened enabling loading from the outside of the system 3D printed parts on the shelf structure and/or closing the sealable opening of the debinding oven. Further, using the debinding oven as a load lock to the sintering furnace may enable pumping down the debinding oven and raising the temperature of the debinding oven to the debinding temperature while maintaining a desired profile of pressure for a predetermined debinding time in the debinding oven. In at least some instances, using the debinding oven as a load lock to the sintering furnace may enable cleaning of the debinding oven atmosphere from contaminants and/or opening the gate valve, for example, moving the shelf structure from the debinding hot zone volume to the sintering hot zone volume and closing the gate valve.

In at least some embodiments, moving the shelf structure from the debinding hot zone volume to the sintering hot zone volume may include at least some of the following steps: (i) with an actuator located out of the sintering furnace a lock portion may be moved and/or controllably engaged with the shelf structure from the debinding hot zone volume to the sintering hot zone volume until the shelf structure rests on a predetermined seat; (ii) disengaging the lock portion from the shelf structure; and/or (iii) moving the lock portion out of the sintering hot zone volume such that the gate valve may be brought to the closed position. In at least some instances, moving the shelf structure from the debinding hot zone volume to the sintering hot zone volume may also include preventing (e.g., prohibiting) the opening of the gate valve if the temperature inside the sintering furnace is, for example, not sufficient for preventing the condensation of pollutants in the sintering furnace.

In at least some embodiments, a sintering and debinding system may include a debinding chamber configured to switch between an open state and a closed state, the open state being configured to permit receipt or removal of at least one part within or from the debinding chamber and a sintering chamber operably connected to the debinding chamber and being vertically positioned above or below the debinding chamber. The sintering system may also include a shelf structure configured to receive the at least one part, the shelf structure being movable between the debinding chamber and the sintering chamber and a gate valve configured to switch between an open state and a closed state, the gate valve being configured to selectively permit or block fluid communication between the debinding chamber and the sintering chamber. The gate valve may be configured such that: when the gate valve is in an open state, fluid communication between the debinding chamber and the sintering chamber is permitted and the shelf structure is movable between the debinding chamber and the sintering chamber. The gate valve may further be configured such that, when the gate valve is in the closed state, fluid communication between the debinding chamber and sintering chamber is restricted, and at least one of: (i) movement of the shelf structure between the debinding chamber and the sintering chamber is restricted or (ii) the debinding chamber is configured to permit receipt within and removal of the at least one part from the debinding chamber.

In at least some embodiments, a sintering and debinding method may include placing at least one part inside a debinding chamber, wherein the debinding chamber is operably connected to a sintering chamber and debinding the at least one part by raising a temperature within the debinding chamber to a debinding temperature while sealing the sintering chamber from the debinding chamber. The sintering method may also include transferring the at least one part from the debinding chamber to the sintering chamber while fluid communication is permitted between the sintering chamber and the debinding chamber and sintering the at least one part within the sintering chamber.

In at least some embodiments, a sintering and debinding system may include a debinding chamber including a loading gate configured to switch between an open state and a closed state, the open state of the loading gate being configured to permit receipt or removal of at least one part from within the debinding chamber and a sintering chamber connected to the debinding chamber and positioned adjacent to the debinding chamber. The sintering system may also include a gate valve configured to switch between an open state and a closed state, the gate valve being configured to regulate fluid communication between the debinding chamber and the sintering chamber. The gate valve may be configured such that: when the gate valve is in the open state, fluid communication is allowed between the debinding chamber and the sintering chamber and the at least one part is movable between the debinding chamber and the sintering chamber, and the loading gate is in the closed state. The gate valve may be further configured such that, when the gate valve is in the closed state in which fluid communication between the debinding chamber and the sintering chamber is restricted, at least one of: (i) movement of the at least one part between the debinding oven and the sintering furnace is restricted or (ii) the loading gate is in the open position enabling receipt and removal of the at least one part from the debinding chamber.

These and other features and advantages will become further apparent from the detailed description and accompanying figures that follow. In the figures and description, numerals indicate the various features, like numerals referring to like features throughout both the drawings and the description.

Both the foregoing general description and the following detailed description are exemplary and explanatory only and are not restrictive of the features, as claimed. As used herein, the terms “comprises,” “comprising,” “including,” “having,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Additionally, the term “exemplary” is used herein in the sense of “example,” rather than “ideal.” It should be noted that all numeric values disclosed or claimed herein (including all disclosed values, limits, and ranges) may have a variation of +/- 10% (unless a different variation is specified) from the disclosed numeric value. In this disclosure, unless stated otherwise, relative terms, such as, for example, “about,” “substantially,” and “approximately” are used to indicate a possible variation of +/- 10% in the stated value. Moreover, in the claims, values, limits, and/or ranges of various claimed elements and/or features means the stated value, limit, and/or range +/-10%. The terms “object,” “part,” and “component,” as used herein, are intended to encompass any object fabricated through the additive manufacturing techniques described herein.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure. Further, one or ordinary skill in the art will recognize that the figures are not necessarily to scale. The figures are presented for illustrative reasons only and should not be used to restrict the scope of the enclosed claims. Same references represent the same or similar features in the different figures, unless explicitly recited.

FIG. 1 illustratively depicts a cross-section of a vacuum furnace.

FIG. 2 illustratively depicts at least some components of the vacuum furnace depicted in FIG. 1.

FIG. 3 illustratively depicts at least some components of the vacuum furnace depicted in FIG. 1.

FIG. 4 illustratively depicts a cross-section of a furnace according to at least one embodiment of the present disclosure.

FIG. 5 illustratively depicts a cross-section of a furnace according to at least one embodiment of the present disclosure.

FIG. 6 illustratively depicts a cross-section of a shelf structure according to at least one embodiment of the present disclosure.

FIG. 7 illustratively depicts an elevation view of a lock portion of a shelf structure manipulator according to at least one embodiment of the present disclosure.

FIG. 8A illustratively depicts a cross-section of a furnace according to at least one embodiment of the present disclosure.

FIG. 8B illustratively depicts a schematic view of a manipulator according to at least one embodiment of the present disclosure.

FIG. 8C illustratively depicts a schematic view of exemplary linear and rotational motion mechanisms that may be useful with the furnace of FIG. 8A according to at least one embodiment of the present disclosure.

FIG. 8D illustratively depicts a detail cross-section of the furnace of FIG. 8A according to at least one embodiment of the present disclosure.

FIGS. 9A and 9B illustratively depict a cross section of a furnace according to at least one embodiment of the present disclosure.

FIG. 10 illustratively depicts a cross section of a furnace according to at least one embodiment of the present disclosure.

FIG. 11 illustratively depicts a cross section of a furnace according to at least one embodiment of the present disclosure.

FIG. 12A and 12B illustratively depict cross sections of portions of a furnace according to at least one embodiment of the present disclosure.

### DETAILED DESCRIPTION

Embodiments of the present disclosure include systems and methods for sintering furnaces, for example, for use in additive manufacturing. Reference now will be made in detail to examples of the present disclosure described above and illustrated in the accompanying drawings. Wherever possible, the same reference numbers will be used throughout the drawings to refer to the same or like parts. Numerous details are set forth describing various exemplary embodiments disclosed herein. One skilled in the art, however, will understand that the presently claimed invention may be practiced without all of the specific details discussed below. In at least some instances, well known features have not been described so as not to obscure the claimed invention.

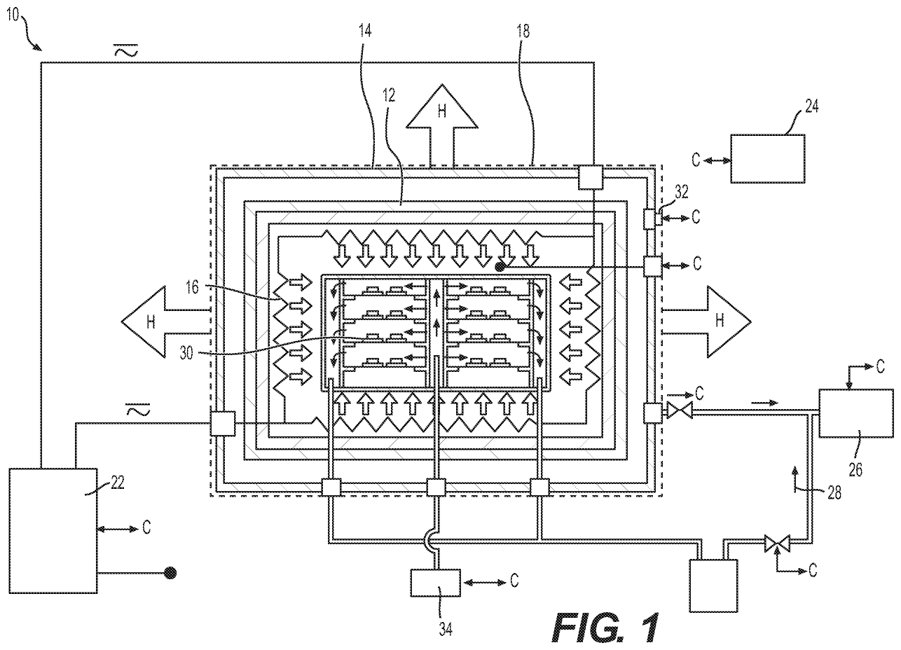

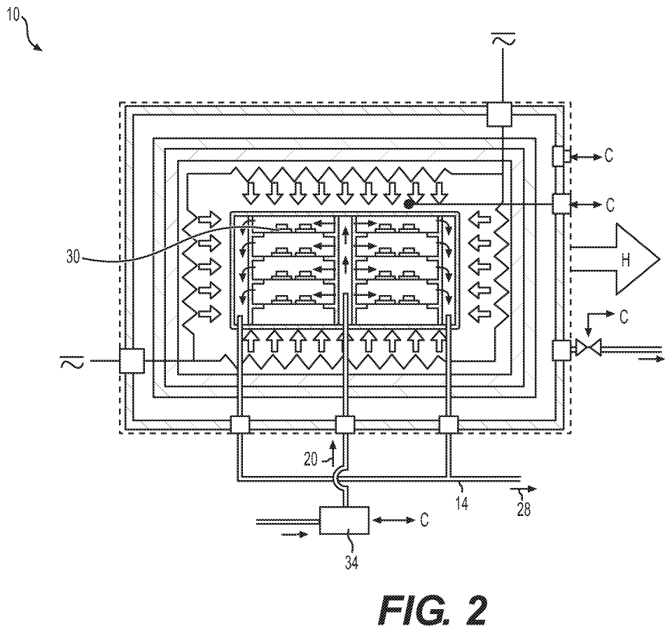

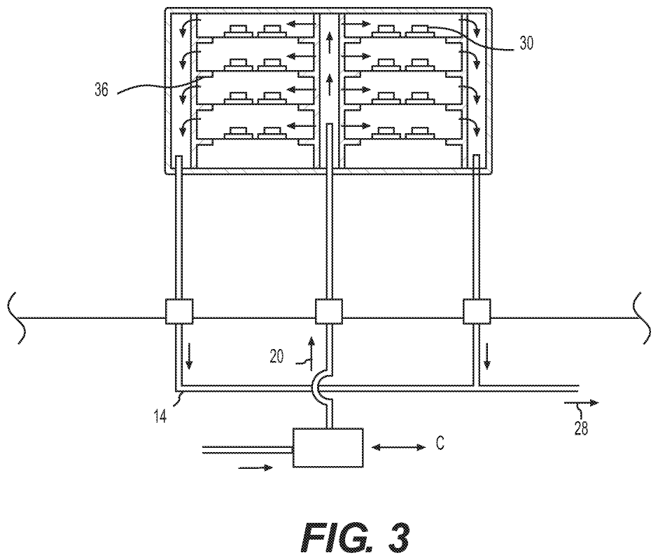

Sintering furnaces (e.g., such as described in relation to FIGS. 1 to 3) may be used in a sequential process comprising: (i) thermally debinding one or more 3D printed part(s) in the furnace at a moderate temperature, for example 500 degrees C., for a number of minutes, or hours, depending on the size and/or number of 3D printed part(s); and subsequently (ii) sintering the 3D printed part(s) in the furnace at temperatures in excess of 1,000 degrees C., for example, for a number of minutes, or hours, depending on the size (and/or number) of 3D printed part(s).

Embodiments of the present disclosure may include a sealable sintering furnace and a sealable debinding oven coupled together by way of a gate valve that has a sufficiently sized opening to permit a shelf structure holding one or more 3D printed parts to pass from the debinding oven to the sintering oven. Further, in at least some instances, the debinding oven may serve as an air lock (load lock chamber) configured to be flushed with inert gas and/or pumped out (e.g., vacuum pumped) after loading of the 3D printed parts.

According to embodiments of the present disclosure, 3D printed parts may be loaded and unloaded from the shelf structure only when the gate valve is closed, and the debinding oven may be pumped out following each loading of the 3D printed parts so as to maintain the furnace at a very low pressure (vacuum), which may allow for a chamber of the furnace to be essentially unexposed to atmospheric contaminants, such as moisture. Further, in at least some instances, sintering furnaces described herein may not require human contact and/or may be kept at moderately elevated temperatures before and between runs (e.g., thermal processing operations) to maintain a relatively constant condition of vacuum baking to maintain high purity.

Small furnaces (e.g., such as furnace 10 described in relation to FIGS. 1 to 3) having a hot zone (or working zone) with a volume of approximately one cubic foot may have power requirements as high as 20 or more kilowatts, which may be too large to be installed in a typical human-friendly work space. Office-friendly relatively small-sized furnaces having hot zone volumes of about one cubic foot, but having low power consumption, such as of less than about six kilowatts in a steady state may be achieved by the exemplary configurations described herein. Conventional sintering furnaces may, during the initial debinding cycle, create a dominant source of contaminants that may condense within the system and later contaminate or otherwise degrade the sintering process. Accordingly, systems according to embodiments of the present disclosure, may separate and isolate the debinding process from the debinding oven, and inhibit condensation such that only trace amounts of debinder over enter the sintering furnace.

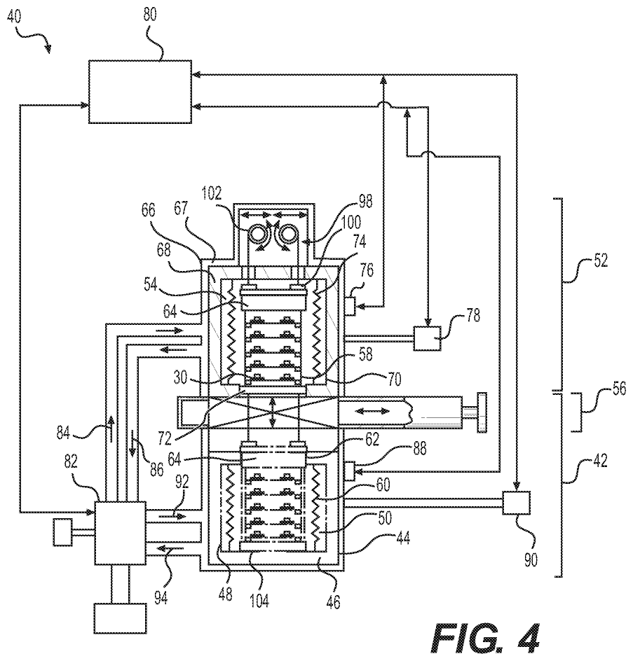

FIG. 4 is a partially-schematic cross-sectional illustration of a relatively low-power powder metal sintering system 40. In exemplary embodiments, system 40 may include: a sealable sintering furnace 42 having walls 44 covered by one or more inwardly-extending layers of sintering insulation 46. An inward face 48 of sintering insulation layer 46 may define a sintering hot zone volume 50 in which sintering temperatures may be achieved for sintering processing. In exemplary embodiments, system 40 may also include a sealable debinding oven 52 having a debinding hot zone volume 54, and the sealable sintering furnace 42 may include a controllably-actuatable gate valve 56, gate valve 56 being arranged to: in an open position (illustrated in FIG. 4) permit translation or other movement of a shelf structure 58 configured to support one or more parts 30. In at least some embodiments, shelf structure 58 may be configured to translate from debinding hot zone volume 54 to sintering hot zone volume 50 and, in an opposite direction, from sintering hot zone volume 50 to debinding hot zone volume 54. When gate valve 56 is in a closed position, gate valve 56 may be configured to restrict gaseous communication between the outside and the inside of the sintering furnace 42.

In exemplary embodiments, sintering furnace 42 may include at least one heating element 60 in the sintering hot zone volume 50, the sintering insulation layer 46 and the at least one heating element 60 being arranged for bringing a part 30 in the sintering hot zone volume 50 to a sintering temperature in excess of 900 degrees centigrade using no more than 8 kW steady state of holding power per cubic foot of the sintering hot zone volume 50. In exemplary embodiments, debinding oven 52 may be arranged for bringing a part 30 in debinding hot zone volume 54 to a debinding temperature in excess of 100 degrees centigrade. Debinding oven 52 may a sealable opening (not shown in FIG. 4) arranged for: when in an open position, allowing loading of one or more parts 30 from the outside of the system 40 on shelf structure 58 when the shelf structure 58 is held outside of the sintering hot zone volume 50; and when in a closed position, restricting gaseous communication between the outside and the inside of the debinding oven 52. In exemplary embodiments, gate valve 56 may be in the closed position when the sealable opening is in the open position, such that the debinding oven 52 may operate as a load lock chamber for isolating the sintering furnace 42 from exposure to atmospheric contaminants.

In exemplary embodiments, debinding oven 52 may include a sealable chamber 66 having walls 67 covered inwardly by a debinding insulation layer 68, an inward face of the debinding insulation layer 68 defining the debinding hot zone volume 54. Debinding insulation layer 68 may include a debinding insulation opening 70 that allows for moving the shelf structure 58 into the debinding hot zone volume 54. In exemplary embodiments, debinding oven 52 may be arranged above the sintering furnace 42, gate valve 56 being arranged vertically between the debinding hot zone volume 54 and the sintering hot zone volume 50; and a bottom portion of the shelf structure 58 may be covered with a bottom insulation 72 having dimensions that substantially match those of sintering insulation layer 46 and is arranged such that bottom insulation 72 may be aligned with the debinding insulation layer 68 and at least partly close the debinding insulation opening 70 when the shelf structure 58 is in the debinding hot zone volume 54. According to embodiments of the present disclosure, bottom insulation 72 may be of a type that does not degrade physically at the sintering temperature.

In exemplary embodiments, debinding insulation 68 may include a relatively low-cost ceramic insulation that would mechanically degrade if insulation 68 were exposed to sintering temperatures. In exemplary embodiments, debinding oven 52 may include one or more heating elements 74 arranged in the debinding hot zone volume 54, which may include a wire heater, and/or that may be one of a Kanthal or a Nichrome heating element. In exemplary embodiments, the debinding temperature may be from about 100 to about 1,000 degrees centigrade; preferably from about 350 to about 600 degrees centigrade.

In exemplary embodiments, debinding oven 52 may include a first temperature sensor 76 configured to monitor a temperature representative of the temperature in shelf structure 58 when in the debinding hot zone volume 54. The first temperature sensor 76 may include a thermocouple sensor having a thermocouple junction in thermal proximity to shelf structure 58 when shelf structure 58 is positioned within debinding hot zone volume 54.

In exemplary embodiments, debinding oven 52 may include a debinding oven pressure sensor 78 configured to generate a sensor signal representative of pressure within debinding hot zone volume 54. Debinding oven 52 may, for example, include a debinding oven controller or controller 80 configured to control a debinding oven atmosphere control manifold 82 in response to signals from debinding oven pressure sensor 78. Manifold 82 may be arranged to provide an inlet gas flow 84 of processing gas into the debinding oven in a controllable manner (e.g., in response to control signals generated by controller 80).

In exemplary embodiments, manifold 82 may be arranged to controllably pump gas out of the debinding oven 52 to cause an outlet gas flow 86.

In exemplary embodiments, controller 80 may be arranged (e.g., programmed) for controlling a pressure in the debinding oven 52 by: monitoring pressure in debinding hot zone volume 54; and controllably balancing an inlet flow rate of inlet gas flow 84 and outlet gas flow 86.

In exemplary embodiments, controller 80 may be configured for controlling outlet gas flow 86 by one or more of: a) toggling on/off (e.g., controllably opening and closing) a controllable valve (for example, an electronically-controlled valve arranged in manifold 82) at determined times; b) controlling an adjustable flow valve (arranged in manifold 82, for example); or c) changing a pumping rate of a pump (a pump arranged in manifold 82, for example) coupled to an outlet tube.

In exemplary embodiments, controller 80 may be arranged for controlling the inlet gas flow 84 in debinding oven 52 by actuating a mass flow controller (for example arranged in manifold 82). Controller 80 may comprise one or more of a programmable logic controller (PLC), a computer, a microchip, or an embedded control system (e.g., a custom engineered control system). Controller 80 may include one of an open loop and a state machine; and/or one or more microchip-controlled embedded controllers.

In exemplary embodiments, manifold 82 may be arranged for implementing at least one of the following operations: a) displacing atmospheric air out of the debinding hot zone volume 54 by introducing a predetermined gas, such as a purified inert gas, into the debinding hot zone volume; b) bringing the debinding hot zone volume 54 to a predetermined debinding pressure (e.g., a relatively low pressure) by pumping out the debinding oven 52; c) maintaining a predetermined debinding pressure (e.g., a relatively low pressure) in the debinding hot zone volume 54 while gas (e.g., vaporized or otherwise volatilized binder) is emitted by a part 30 in debinding hot zone volume 54; d) maintaining a predetermined debinding pressure (e.g., a relatively low pressure) in debinding hot zone volume 54 while gas is emitted by a part 30 in debinding hot zone volume 54 and while injecting a processing gas in debinding oven 52; e) bringing debinding hot zone volume 54 to a room pressure; or 0 bringing debinding hot zone volume 54 to a room pressure while flushing contaminants out of debinding oven 52.

According to embodiments of the present disclosure, debinding oven 52 may be arranged to controllably bring the debinding hot zone volume from atmospheric pressure to a predetermined debinding pressure, and reciprocally. According to embodiments of the present disclosure, the debinding pressure may range from, for example, about 0.05 to about 100 Torr. In particular, the predetermined debinding pressure may be below about 10 Torr.

According to embodiments of the present disclosure, debinding oven 52 may be arranged for, when sealable opening and gate valve 56 are in closed position, baking out the debinding hot zone volume 54 and a part 30 on the shelf structure 58 in the debinding hot zone volume 54.

According to embodiments of the present disclosure, debinding oven 52 may be arranged for having its atmosphere flushed after a debinding operation (or vacuum bake-out) and before a lowering of the temperature in debinding hot zone 54 below a temperature at which debinding operation pollutants condense. As described above, debinding oven 52 may have its atmosphere flushed by a continuous input and output of gas. Additionally or alternatively, debinding oven 52 may have its atmosphere flushed in a single operation after debinding.

According to embodiments of the present disclosure, system 40 may be arranged to bring hot zone volume 50 of sintering furnace 42 to a predetermined sintering temperature when gate valve 56 is in the closed position. System 50 may be arranged to bring hot zone volume 50 to a predetermined sintering furnace idle temperature (e.g., a temperature lower than the predetermined sintering temperature), prior to opening gate valve 56. According to embodiments of the present disclosure, the sintering furnace idle temperature may be a temperature sufficient for preventing the condensation of fluids or pollutants (e.g., water, and/or vaporized debinder) in the sintering furnace. According to embodiments of the present disclosure, sintering furnace idle temperature may range from about 200 to about 500 degrees centigrade.

In exemplary embodiments, and as described above, gate valve 56 may be arranged vertically between debinding hot zone volume 54 and sintering hot zone volume 50. Sintering insulation layer 46 may include a top sintering insulation layer opening 62 configured to permit movement of shelf structure 58 into sintering hot zone volume 50. A top portion of the shelf structure 58 may be covered with a top insulation 64 having dimensions that match the dimensions of the sintering insulation layer 46, and in particular, top sintering insulation layer opening 62, such that the top insulation 64 may be aligned with sintering insulation layer 46 and at least partly close the sintering insulation layer opening 62 when the shelf structure 58 is in the sintering hot zone volume 50 (as illustrated in FIG. 4). According to embodiments of the present disclosure, top insulation 64 may be of a type of insulation that does not degrade at the sintering temperature. Top insulation 64 may include a same material as insulation layer 46. However, if desired, top insulation 64 may be made of a different material as insulation layer 46. For example, insulation layer 46 may include graphite or ceramic fibers, whereas top insulation 64 may include a plurality of layers of molybdenum.

It is noted that, while FIG. 4 illustrates an exemplary configuration of system 40 in which debinding oven 52 is positioned above sintering furnace 42, embodiments of the present disclosure also contemplate a system 40 in which the sintering furnace is instead positioned above the debinding oven, or a system 40 in which the sintering furnace and debinding oven are arranged side-by-side. The respective positions of gate valve 56, insulation openings (e.g., opening 62) and the insulation arranged on the sides of shelf structure 58 for at least partly closing the insulation openings may be altered, as necessary, in these embodiments in a manner consistent with the respective positions of debinding oven 52 and sintering furnace 42.

According to embodiments of the present disclosure, sintering furnace 42 may be configured to operate at a sintering pressure within a predetermined range of relatively low pressures, such as a pressure below one atmosphere. Walls 44 of sintering furnace 42 and, when in a closed position, gate valve 56, may form a vacuum chamber. According to embodiments of the present disclosure, the sintering pressure may be below about 10 Torr. In particular, an exemplary ideal sintering pressure may be below about 1 Ton. In some instances, for example for tool or mid-carbon steels where it may be beneficial to adjust the carbon activity of the atmosphere to reach equilibrium with the parts, a moderate low pressure may be desired, such as on the order of about 20 and about 300 Torr, to assist in this balance of carbon activity. According to some embodiments, the low pressures may be near-atmospheric or even slightly positive (e.g., about 400 to about 900 Torr). Such pressures may be useful, for example, when sintering powders with relatively high initial oxygen contents that may lead to large amounts of decarburization (another example would be for aluminum nitride formation prior to infiltration which is performed in these higher pressure ranges). According to embodiments of the present disclosure, the sintering pressure range may change over time according to a predetermined curve that may depend on the sintering process. According to embodiments of the present disclosure, sintering insulation layer 46 may include one or more of a graphite insulation, a high-temperature ceramic insulation, or a multilayer molybdenum insulation. According to embodiments of the present disclosure, sintering insulation layer 46 may be of a type that does not significantly degrade physically at sintering temperatures described herein. According to embodiments of the present disclosure, the sintering temperature may range from about 900 to about 1,500 degrees centigrade. In particular, the sintering temperature may range from about 1,200 to about 1,400 degrees centigrade.

According to embodiments of the present disclosure, heating element 60 of sintering furnace 42 may include one or more of a graphite heater, a SiC heater, a carbon composite heater, or a heater including one or more other suitable conductive refractory materials. According to embodiments of the present disclosure, sintering furnace 42 may include a sintering furnace temperature sensor or second temperature sensor 88 configured for monitoring a temperature representative of the temperature in shelf structure 58 in sintering hot zone volume 50. Sintering furnace temperature sensor 88 may include a thermocouple sensor having a thermocouple junction in thermal proximity to shelf structure 58 when shelf structure 58 is positioned in sintering hot zone volume 50.

According to embodiments of the present disclosure, sintering furnace 42 may include a sintering furnace pressure sensor 90 arranged for providing a sensor signal representative of the pressure within the sintering hot zone volume 50. According to embodiments of the present disclosure, sintering furnace 42 may include a sintering furnace controller 80 (which may be included in debinding oven controller 80, or provided as one or more separate controllers) configured or arranged (e.g., programmed) to control a sintering furnace atmosphere control manifold 82 (which may be included in, or provided separately from, debinding oven atmosphere control manifold 82) in response to signals from sintering furnace pressure sensor 90.

According to embodiments of the present disclosure, manifold 82 may include a valve and tube manifold, that may be in controllable gaseous communication with the sintering furnace 42 by way of inlet and outlet tubes. It is noted that pressure gauges, and other sensors, such as temperature sensors, may also be employed within the manifold. For example, manifold pressure may be monitored such that chamber pressure may be inferred from manifold pressure measurements. Gas temperatures may be monitored within manifold 82 for any desired purpose including, but not limited to, process control and safety monitoring.

According to embodiments of the present disclosure, manifold 82 may be configured to controllably provide an inlet gas flow of processing gas 92 to sintering furnace 42. According to embodiments of the present disclosure, manifold 82 may be arranged to controllably pump gas out of the sintering furnace to cause an outlet gas flow 94.

According to embodiments of the present disclosure, controller 80 may be configured for controlling the pressure in sintering furnace 42 by monitoring the pressure in sintering furnace 42, and controllably balancing an inlet flow rate of the inlet gas flow 92 and the outlet gas flow 94.

According to embodiments of the present disclosure, sintering furnace controller 80 may be configured for controlling the outlet gas flow 94, out of sintering furnace 42, by one or more of: a) toggling on/off a controllable valve (e.g., an electronic valve in manifold 82) at determined times; b) controlling an adjustable flow valve (e.g., an electronic valve in manifold 82); and changing a pumping rate of a pump (e.g., a pump in manifold 82 or operably connected to manifold 82) coupled to an outlet tube.

According to embodiments of the present disclosure, controller 80 may be configured for controlling the inlet gas flow 92 in sintering furnace 42 by actuating a mass flow controller (e.g., in manifold 82). According to embodiments of the present disclosure, sintering furnace controller 80 may include one or more of a PLC, a computer, a microchip, or a custom engineered embedded control system. If desired, and as described above, controller 80 may include one of an open loop and a state machine; and may include microchip-controlled embedded controllers.

According to embodiments of the present disclosure, sintering furnace atmosphere control manifold 82 coupled to the sintering furnace 42 may be configured for implementing at least one of the following operations: a) bringing the sintering hot zone volume 50 to a sintering pressure within a predetermined range of pressures (e.g., relatively low pressures) by pumping gas out of the sintering furnace 42; b) introducing processing gas to sintering furnace 42, such as an inert gas (e.g., argon and/or nitrogen), a gas mixture including, in majority, an inert gas and also including, in a minority, reactive gas such as hydrogen or carbon monoxide, (e.g., 97% argon or nitrogen and 3% hydrogen) at a controlled and variable flow rate, a reactive gas such as pure hydrogen or CO/CO₂; c) maintaining the sintering pressure within the predetermined range of pressures in sintering hot zone volume 50 while injecting a reducing atmosphere in the sintering furnace, for example, such that the reducing atmosphere falls over or surrounds parts 30 arranged on shelf structure 58; d) maintaining the sintering pressure within the predetermined range of pressures in sintering hot zone volume 50 while injecting a processing gas into sintering furnace 42, for example, such that the processing gas falls over or surrounds parts 30 arranged on shelf structure 58; or e) bringing sintering hot zone volume 50 to a room pressure (e.g., before deactivating the system).

In exemplary embodiments, system 40 may include a manipulator 98 configured for moving the shelf structure 58 between debinding hot zone volume 54 and sintering hot zone volume 50 when gate valve 56 is in the open position. In exemplary embodiments, manipulator 98 may include a lock portion 100 configured for controllably engaging with and disengaging from the shelf structure 58. Manipulator 98 may include an actuator 102 located outside with respect to sintering furnace 42 arranged for moving the lock portion 100 between the debinding hot zone volume 54 and the sintering hot zone volume 50.

In exemplary embodiments, shelf structure 58 may be configured to rest in the sintering hot zone volume 50 on a seat 104 (as shown in FIG. 4, for example, seat 104 may be a portion of the sintering insulator 46 at the bottom of sintering hot zone volume 50. Alternatively, seat 104 may include a support arranged on the insulator 46. Manipulator 98 may be arranged for: moving shelf structure 58 to seat 104 when gate valve 56 is in the open position and the shelf structure 58 is in debinding hot zone volume 54, disengaging lock portion 100 from shelf structure 58 and moving lock portion 100 out of sintering hot zone volume 50 such that gate valve 56 may be brought to the closed position.

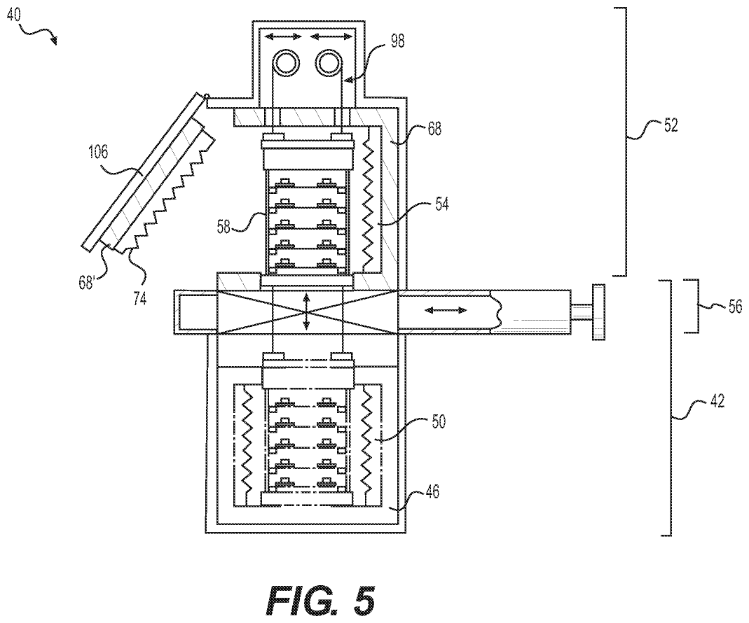

FIG. 5 illustrates an exemplary embodiment of system 40 which may include each of the features of the embodiments described with respect to FIG. 4 and may be substantially similar to the embodiment illustrated in FIG. 4. Additionally, as shown in FIG. 5, debinding oven 52 may be attached to sintering furnace 42 and may include a door 106 for opening and closing the sealable opening. Door 106 may be motorized or manually actuated, e.g., by electronically-controlled and/or manual latches or other suitable mechanisms. As illustrated in FIG. 5, door 106 may include a portion 68′ of debinding insulation layer 68, and optionally, one or more heating elements 74.

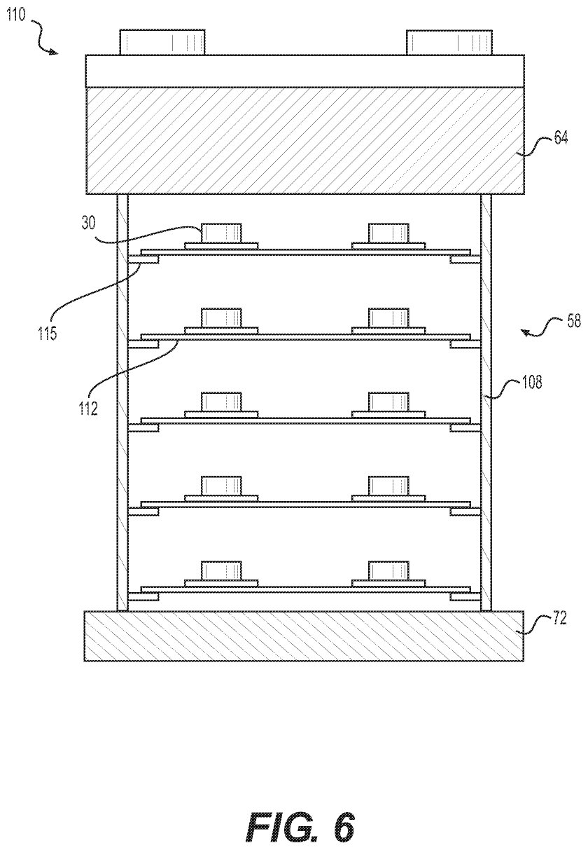

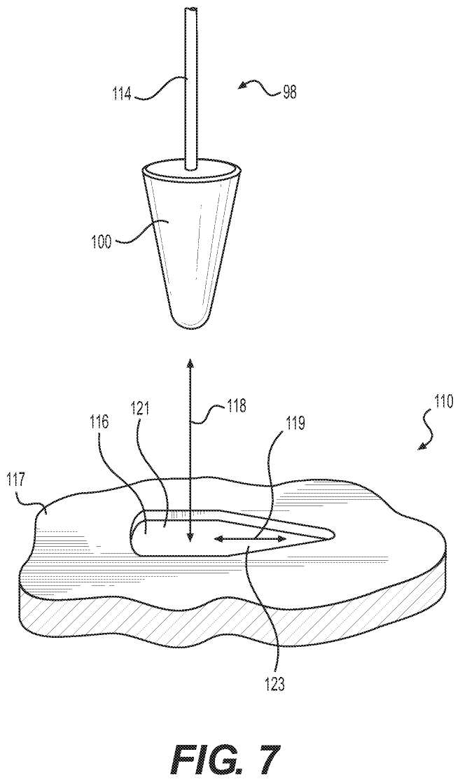

FIG. 6 is a cross-sectional view of shelf structure 58 shown in FIGS. 4 and 5, including a frame 108 having flanges 115 arranged to removably hold a plurality of shelves 112 for supporting one or more parts 30. In one aspect, removable shelves 112 may be removed and replaced with shelves 112 configured to support larger parts 30. Top insulation 64 and bottom insulation 72 may be fixedly or removably attached to the top and bottom of frame 108. In exemplary embodiments, shelf structure 58 may include a handle portion 110 for removably cooperating with a lock portion 100 (FIG. 7) of manipulator 98.

FIG. 7 is an elevation view of a portion of handle 110 arranged for removably cooperating with a lock portion or end 100 of manipulator 98, where manipulator 98 may include at least one elevator cable or wire 114 secured to lock end 100 arranged for controllably holding or releasing handle portion 110. Manipulator 98 may include a cable actuator 102 (FIG. 4) configured to allow movement of lock end 100 upward and downward along direction 118. Lock end 100 may be formed by an enlarged end of cable 114, such as a plumb line. Handle portion 110 may include a slit 116 or opening in a plate 117 above a larger cavity. Slit 116 may include a relatively broad end 121 sized to receive lock end 100 therethrough along a vertical direction 118, and a narrowed end 123 sized to block motion of lock end 100 therethrough (e.g., along a direction parallel to direction 118).

Cable actuator 102 may be configured to allow movement of cable 114 and lock end 100 along approximately vertical direction 118 (and direction(s) approximately parallel to direction 118) as well as an approximately lateral or horizontal direction 119 perpendicular to vertical direction 118. According to at least some embodiments, the cavity under slit 116 may define a substantially constant width equal to the width of broad end 121 of slit 116.

In order to engage lock end 100 with handle 110, actuator 102 may lower lock end 100 (along direction 118) through the larger or broad end 121 of slit 116 into the cavity below slit 116. Actuator 102 may subsequently shift lock end 100 laterally toward under the narrower end 123 of slit 116, and move lock end 100 upward (with respect to direction 118) to a position where lock end 100 is prevented from moving up by interference with plate 117 on opposing sides that define narrow end 123 of slit 116. Once so secured, lock end 100 and handle 110 may move up and down together with respect to direction 118.

In order to disengage lock end 100 from handle 110, actuator 102 may be configured to lower lock end 100 and handle 110 together until handle 110 ceases to descend (e.g., when the bottom of shelf structure 58 rests on seat 104). Actuator 102 may then lower lock end 100 somewhat farther downward (with respect to direction 118) such that lock end 100 is brought out of contact with plate 117. Actuator 98 may be configured to shift lock end 100 laterally along direction 119 toward (and under) broader end 121 of slit 116 (as described below), and move lock end 100 upward along direction 118 until lock end 100 passes through the broad end of slit 116.

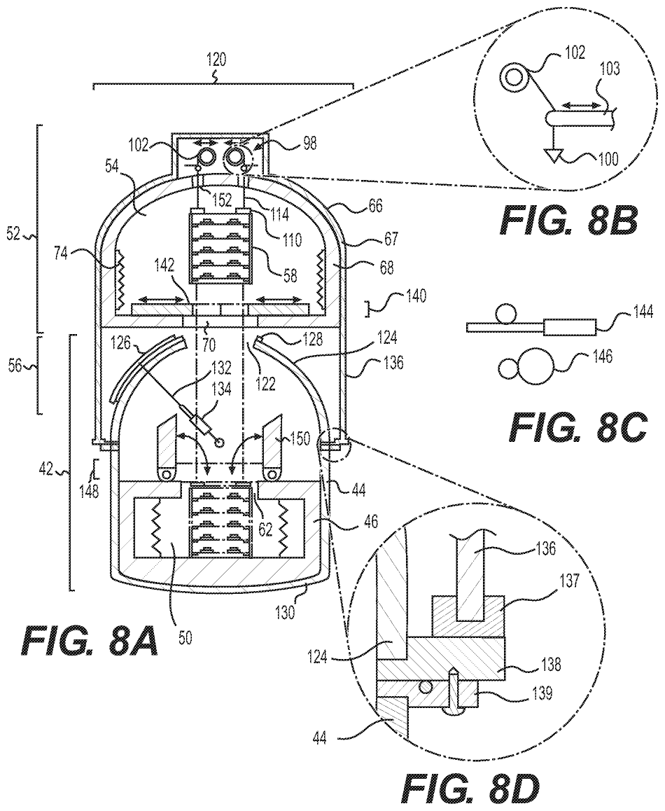

FIG. 8A illustrates exemplary embodiments where debinding oven 52 and sintering furnace 42, including gate valve 56, may be enclosed within a housing 120 having similar horizontal dimensions as the larger of sintering furnace 42 and debinding oven 52. For example, gate valve 56 may be arranged to remain contained within housing 120 when gate valve 56 is in both open and closed positions.

Gate valve 56 may include a pivoting door element moveable between a storage position (gate valve 56 opened) and an active position (gate valve 56 closed). Gate valve 56 may be configured to remain contained within housing 120 when gate valve 56 is in both open and closed positions. For example, gate valve 56 may include a door element that is translateable (e.g., slidable) between a loading, unloading, or storage position (e.g., where gate valve 56 is open) to an active position (e.g., where gate valve 56 is closed). For example, a door element may be slidable along a plane that forms an angle with respect to a plane normal to a loading direction (e.g., a vertical direction) of the sintering furnace 42. A combination of the pivoting and the sliding movement of the door, or any combination of vertical motion and horizontal motion of the door, so as to move away from gate opening 122, may allow the door to completely clear gate opening 122 while moving horizontally by less than the horizontal size of gate opening 122 in the direction, and thus may allow gate opening 122 to be completely clear, while the door remains within the housing of the system.

An open position of an exemplary gate valve 56 is illustrated in FIG. 8A. Gate valve 56 may include a gate opening 122 in a curved wall 124 of sintering furnace 42 that has a first radius of curvature. Gate valve 56 may further include a door having at least a curved plate 126 with a second radius of curvature, curved plate 126 being movably secured such that plate 126 may be moved away from the gate opening 122 to establish an open position of gate valve 56. Additionally, curved plate 126 may be movable to a position above gate opening 122 to establish a closed position of gate valve 56. To facilitate opening and closing of gate valve 56, curved plate 126 may have a perimeter larger than the perimeter of gate opening 122.

In exemplary embodiments, a periphery of curved plate 126 may be arranged for sealingly engaging with a seal seat 128, which may include, for example, a silicone seal, viton seal or any suitable elastomeric gasket and/or o-ring seals, around gate opening 122.

In exemplary embodiments, the first and second radius of curvature may be identical or substantially identical. Alternatively, the first radius of curvature may be larger than the second radius of curvature or the first radius of curvature may be smaller than the second radius of curvature.

In exemplary embodiments, sintering furnace 42 may have substantially circular horizontal dimensions (e.g., a projection of a horizontal plane of sintering furnace 42 may form a circle). Gate opening 122 may also be circular or substantially circular, and curved wall 124 and curved plate 126 may both have the shape of a spherical cap. In particular, walls 44 of sintering furnace 42 may include a spherical cap-shaped curved wall section 124 on top of a cylindrical section. Such a shape may be particularly well-suited to manufacturing efficiently and economically with the vacuum chamber of furnace 42. According to embodiments of the present disclosure, walls 44 of sintering furnace 42 may include a spherical cap-shaped curved wall portion 130 (which may have a different radius of curvature as compared to curved wall section 124) at the bottom of a cylindrical section of walls 44 to facilitate manufacturing. According to embodiments of the present disclosure, walls 44 and curved plate 126 may include materials such as steel, stainless steel, aluminum, cast iron and/or aluminum, and may be impregnated for reducing porosity which may tend to form in castings. When debinding oven 52 is not a vacuum oven, a wider variety of shells may be used, including shells of other shapes, for example, to sealably provide an inert environment during debinding.

According to embodiments of the present disclosure, gate valve 56 may include at least one swing arm 132 that pivotally couples curved plate 126 to housing 120 of system 40 (or, if desired, to walls 44 of sintering furnace 42). Swing arm 132 may be configured to guide and move curved plate 126 for orbital motion, or along an arced path, with respect to a portion of curved wall portion 124, so as to achieve the open and closed positions of gate valve 56. Such orbital motion may allow curved plate 126 to move vertically, as well as horizontally, when moving away from gate opening 122, allowing curved plate 126 to completely clear gate opening 122 while moving horizontally by less than the horizontal size of gate opening 122.

According to embodiments of the present disclosure, swing arm 132 may be controllably lengthened to facilitate motion of curved plate 126 to open and close gate valve 56. Similarly, swing arm 132 may be controllably shortened to facilitate sealing curved plate 126 against seal seat 128. For example, force applied to shorten swing arm 132 may provide a biasing force that compresses the gasket or o-ring. If desired, controller 80 may allow debinding pressure to exceed the sintering chamber pressure during sintering, and thus increase the sealing force. For example, during sintering, it may be desirable to allow pressure within the debinding oven 52 to approximately reach atmospheric pressure and provide, for example, about 15 psi, which may tend to crush the gasket seal and generate a high-quality seal. Swing arm 132 may be controllably lengthened and shortened using at least one linear actuator 134 (e.g., a motorized acme screw actuator). If desired, swing arm 132 may include two branches, each being similar to the illustrated branch, arranged symmetrically on two sides of sintering furnace 42.

In some embodiments, swing arm 132 and actuator 135 may be located outside of curved wall 124 while remaining inside chamber 66. Swing arm 132 and actuator 134 may together form a moving arrangement for pivotally translating curved plate 126. If desired, this moving arrangement may be replaced with one or more other moving arrangements without departing from the scope of this disclosure. For example, a pair of curved roller tracks may be fixedly supported on curved wall 124 to cooperate with respective aligned roller wheels attached to curved plate 126 to facilitate rolling motion of the wheels along the tracks and thereby pivot the curved plate 126 from the storage position (gate valve 56 opened) to the active position (gate valve 56 closed). If desired, forming cylindrical portion 136 with a relatively larger diameter may facilitate the use of a horizontal flat wall in place of curved wall 124, provided that sufficient horizontal clearance exists such that that plate 126 is able to completely clear the seal perimeter. However, the curvature of curved wall 124 may provide a curved circumference having a diameter that is greater than a diameter of curved plate 126. Thus, curved wall 124, contained within cylindrical portion 136, may facilitate pivotal translation of curved plate 126 along the greater circumference of curved wall 124 by way of the moving arrangement. In at least some embodiments, the curvature may enable a larger diameter curved plate than would otherwise be configured to fit within a given diameter of cylindrical portion 136, and thus, may allow for a correspondingly larger diameter seal perimeter 128.

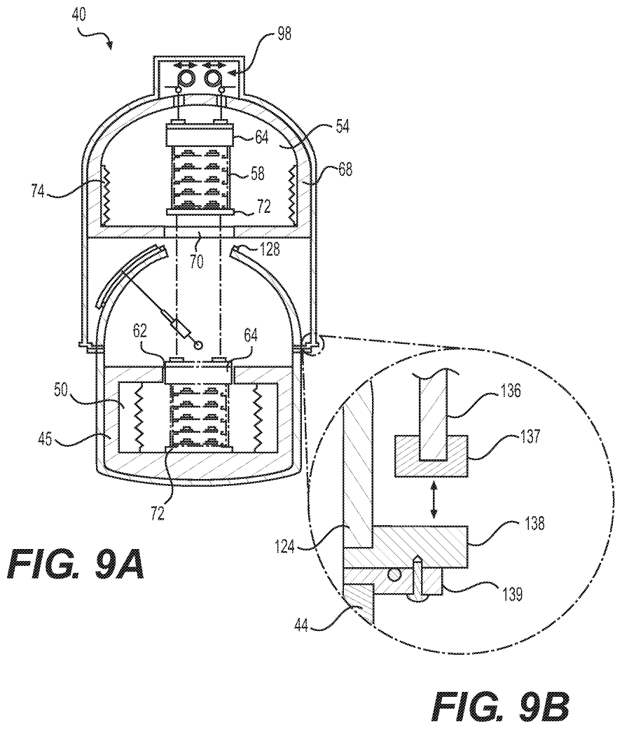

As shown in FIGS. 8A-8D, debinding oven 52 may have a domed-shaped, relatively easy to manufacture sealable chamber 66 configured to be sealed with a main user seal, and raised and lowered to provide access for loading and unloading parts from the debinding oven. Sintering furnace 42 may be sealed (e.g., at assembly) by way of vacuum-grade flange assembly having a first flange portion 138 sealably attached to curved wall 124 and a second flange portion 139 facing first flange portion 138 and sealably attached to walls 44. Flange portions 138 and 139 may be sealed to one another so as to form an assembly having a service seal or service flange using an elastomeric seal, such as an o-ring, which may be sealed using flange bolts. The seal between flange portions 138 and 139 may be considered a service flange (as opposed to a user flange) as this service flange may be opened for repair, service and/or rebuilding of the sintering furnace. As illustrated in FIGS. 8A-8D, main user seal 137 may be a rubber gasket and/or o-ring that is formed (for example by molding) to conform to a lower perimeter of cylindrical portion 136 of debinding oven 52. The inclusion of user seal 137 may be advantageous at least for the reason that it requires no additional flange. When debinding oven 52 is raised in the open position (see FIG. 9B), gate valve 56 may be closed as described herein. From this position, access to shelf structure 58 may be gained, for example, by first raising debinding oven 52 to provide clearance and then lowering shelf structure 58 to drop shelf structure 58 below the bottom of the oven insulation.

As illustrated in FIGS. 8A-8D, debinding insulation layer 68 may be arranged such that debinding insulation opening 70 opens above gate opening 122 at a sufficient distance such that arm 132 may be configured to move curved plate 126 between the open and closed positions of gate valve 56.

As illustrated in FIGS. 8A-8D, alternatively to (or in addition to) covering a bottom portion of shelf structure 58 with a bottom insulation 72 (FIG. 4) for closing the debinding hot zone volume 54, debinding oven 52 may include a debinding insulation latch 140 configured to controllably open or close the debinding insulation opening 70 with, for example, one or more horizontally-moveable debinding insulation plates 142 (e.g., of a same type of insulation as debinding insulation layer 68). With reference to FIG. 8C, debinding insulation latch 140 may be actuated using a rotational mechanism 146 (e.g., one or more motors causing a cogwheel to rotate) or a linear motion mechanism 144 (e.g., a teethed slider causing a cogwheel to rotate) arranged for operating at relatively low pressure. Mechanism 144 or 146 may be arranged within the debinding oven 52 while remaining outside of insulation layer 68.

As illustrated in FIGS. 8A-8D, sintering insulation layer 46 may be arranged so that sintering insulation opening 62 may open at a position below gate opening 122 at a distance that facilitates positioning of a sintering insulation latch 148 between gate opening 122 and sintering insulation opening 62. Sintering insulation latch 148 may be configured to controllably open or close sintering insulation opening 62 with one or more mobile sintering insulation plates 150. Additionally or alternatively, sintering insulation latch 148 may be configured to cover a top portion of shelf structure 58 with a top insulation 64 (FIG. 4). In exemplary embodiments, sintering insulation latch 148 may be actuated using a rotational mechanism or linear motion mechanism as described above (FIG. 8C). The rotational mechanism or linear motion mechanism may be, for example, arranged within the sintering oven 42 between insulation layer 46 and gate valve 56. In exemplary embodiments, sintering insulation latch 148 may include insulation plates 150 (e.g., of a same or similar type of insulation as insulation layer 46) configured to be controllably actuated to pivot with respect to axes normal to an axis of the sintering insulation opening 62.

According to embodiments of the present disclosure, cable actuator 102 of manipulator 98 (which may include for example, one or more controllably-rotatable wire spools for controllable movement horizontally in different directions) may be arranged in a top part of debinding oven 52, between walls 67 and debinding insulator layer 68, the one or more cables and/or wires 114 of manipulator 98 passing through relatively thin slits 152 in debinding insulation layer 68 into the debinding hot zone volume 54. Cable actuator 102 may be actuatable (e.g., for horizontal movement as represented by double-headed arrows above each cable actuator 102 in FIG. 8A) to controllably engage handle 110 of shelf structure 58 and move shelf structure 58 between debinding hot zone volume 54 and sintering hot zone volume 50 through opened gate valve 56, as described above. If desired, as shown in FIG. 8B, cable actuator 102 may remain fixed, while a slidable cable manipulator such as a sliding plate or rod 103 may control each cable for horizontally moving lock portion 100.

In exemplary embodiments, debinding oven 52 and sintering furnace 42 may each have substantially rectangular horizontal dimensions (the projection of a horizontal plane of each may be a rectangle). Thus, FIG. 8A may correspond to a cross-section of a “postal box” shaped debinding oven 52 arranged atop a sintering furnace 42 having a similar shape. According to embodiments of the present disclosure, a “postal box” shape may include a parallelepiped wall section topped by a curved wall section having the shape of an axial section of a cylinder having a rotational axis parallel to one of the horizontal dimensions of the parallelepiped. With respect to sintering furnace 42, gate opening 122 and curved plate 126 may each also have the shape of an axial section of a cylinder having substantially the same axis as curved wall section 124.

FIGS. 9A and 9B illustrate a system 40, according to embodiments of the present disclosure, that may be substantially similar to system 40 of FIGS. 8A-8D, but may instead include a bottom insulation 72 on a bottom portion of shelf structure 58 instead of debinding insulation latch 140. Additionally, system 40 may include a top insulation 64 on a top portion of shelf structure 58 instead of sintering insulation latch 148 of FIG. 8A. As shown in FIG. 9A, shelf structure 58 may be brought to a position (not shown in FIGS. 9A and 9B) where bottom insulation 72 may be aligned with the edges of debinding insulation layer 68 and at least partly closes debinding insulation opening 70. As shown in FIG. 9A, in order to close sintering hot zone volume 50, shelf structure 58 may be positioned by manipulator 98 such that top insulation 64 is aligned with the edges of sintering insulation layer 46. While in this position, top insulation 64 may at least partially close the sintering insulation opening 62. If desired, a gap may remain between opening edge and the insulator on shelf structure 58 when shelf structure 58 is so positioned.

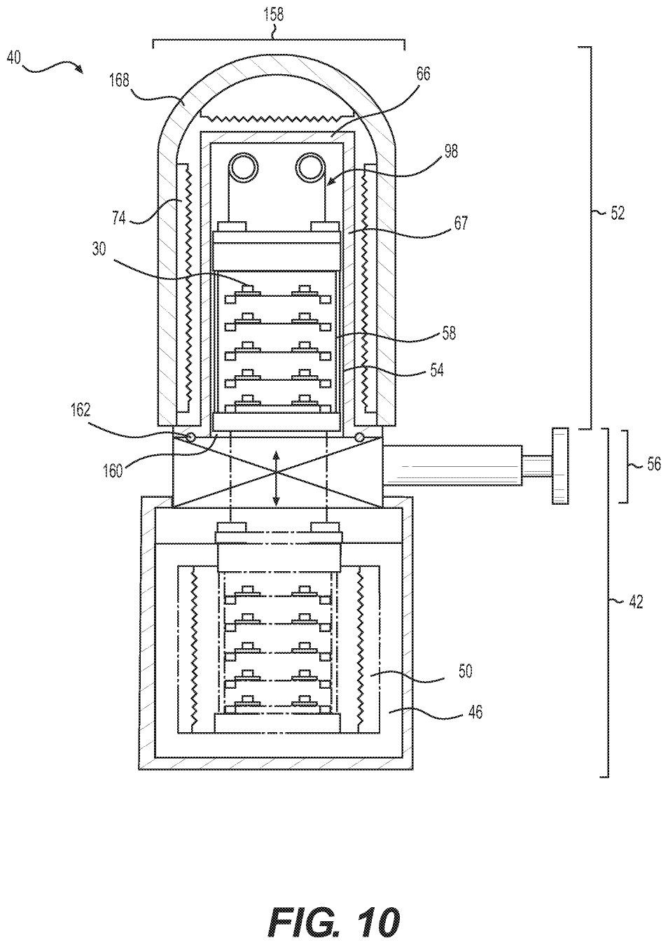

FIG. 10 illustrates system 40, according embodiments of the present disclosure, in which debinding oven 52 may form a bell jar structure 158, wherein opening 160 of bell jar structure 158 forms a sealable opening of debinding oven 52, and may be configured to cooperate with a seal seat 162 arranged on a top periphery of gate valve 56. Shelf structure 58 may rest on a bottom part of debinding oven 52, for example, formed by a top portion of gate valve 56, and may be disengaged from manipulator 98 before raising the bell jar structure 158 to provide access to shelf structure 58. Once shelf structure 58 is loaded with one or more parts 30, bell jar structure 158 may be sealed and shelf structure 58 may be engaged by manipulator 98. For example, after debinding, manipulator 98 may lower shelf structure 58 into the sintering hot zone volume 50 when gate valve 56 is open.

As also shown in FIG. 10, debinding oven 52 may include a sealable chamber 66 having walls 67 covered outwardly by a debinding insulation layer 168. In some embodiments, an inward face of the walls 67 of debinding oven 52 may define debinding hot zone volume 54 of debinding oven 52. Bell jar structure 158 may be sealed relative to the outside atmosphere with a seal 162, such as an elastomeric o-ring or gasket. Seal 162 may be arranged in good thermal contact with the gate valve 56 to avoid overheating seal 162 (which may include elastomeric material, for example). The insulation under shelf structure 58 may be arranged to further protect seal 162 from thermal damage.

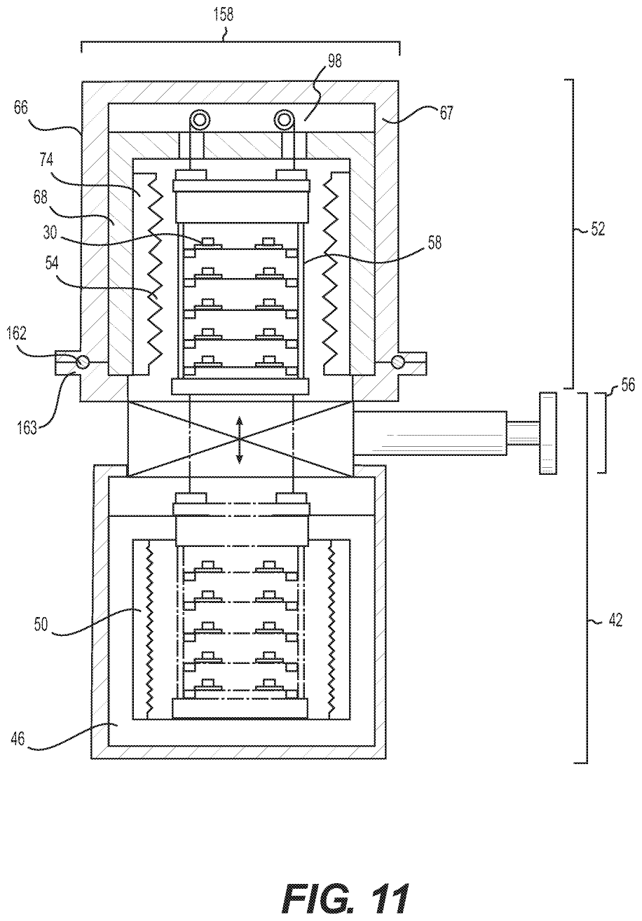

FIG. 11 illustrates an exemplary system 40 wherein, as described above with respect to FIG. 10, debinding oven 52 may include a bell jar structure 158. Additionally, as described above with respect to, for example, FIG. 4, system 40 may include a debinding insulation layer 68 that extends internally with respect to vacuum chamber 66.

Bell jar structure 158 may be sealed relative to the outside atmosphere with a seal 162 (e.g., an elastomeric o-ring or gasket) arranged on a top periphery of a flange 163 sealingly attached to a top periphery of gate valve 56, and arranged to bring seal 162 in good thermal contact with gate valve 56 to avoid overheating seal 162.

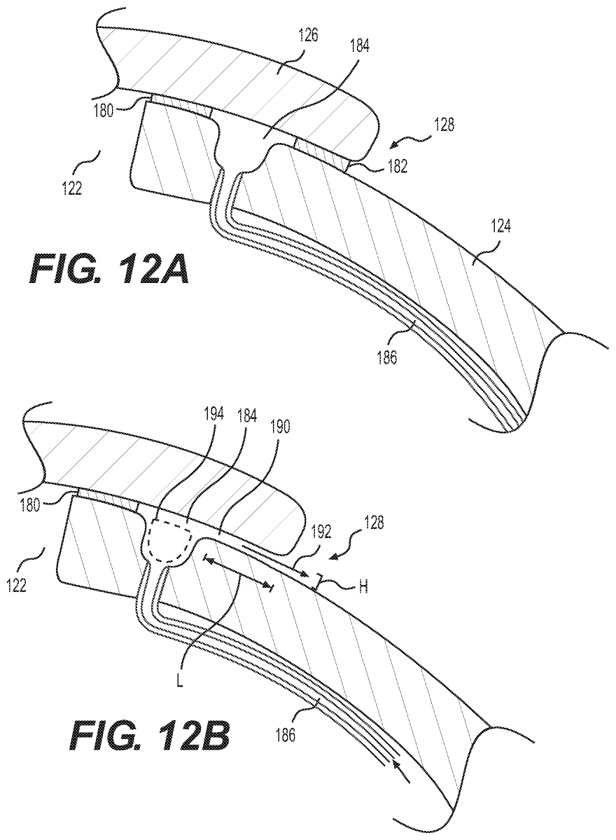

Seal gasket 128 (for example, as shown in FIGS. 8A and 9A) may be subjected to at least relatively moderate levels of heat, which may tend to increase the difficulty associated with forming a robust seal for the heat and environment which gate valve seal may be subjected to. FIGS. 12A and 12B illustrate exemplary embodiments for providing a robust gate valve seal between curved plate 126 and curved wall 124. In some embodiments, as shown in FIG. 12A, the seal arrangement may include an inner seal 180 (such as an inner gasket or o-ring) and an outer seal 182 (such as an outer gasket or o-ring) shaped and positioned to circumscribe opening 122. Seals 180 and 182 may be arranged with a gas flow seal channel 184 therebetween that circumscribes the entire seal perimeter and may extend parallel to, and between, both inner and outer seals 180 and 182. A pumping and/or sweep gas tube 186 may be in fluid communication with gas flow seal channel 184 to evacuate gas flow seal channel 184 with a vacuum pump and/or by injecting sweep gas 192 through channel 184. With reference to FIG. 12A, configurations in which sweep gas is injected through channel 184 may be achieved with use of two tubes at roughly opposite portions of the channel, such that one tube acts as a sweep gas inlet, and the other tube acts as an outlet. The tube seal may extend outside the sintering chamber by way of a sealed tube feedthrough (not shown).

FIG. 12B illustrates an exemplary double seal having an inner seal 180, such as a gasket or o-ring, and an outer seal 190 that may be formed by a Peclet effect “sweep gas” or Peclet seal using clean inert sweep gas 192, such as argon or nitrogen, to provide additional sealing by way of further isolation between the sintering chamber and the debinding oven. This sealing mechanism is described in detail in PCT/US2020/017714, filed on Feb. 11, 2020, the entirety of which is incorporated by reference herein. In at least some embodiments, effective gap sizes (e.g., gap height H) may range from about 0.003 inch to about 0.025 inch. Sweep gas flow rates may range from about 0.1 standard liters per minute (SLM) to about 3.0 (SLM).

System 40 may operate similarly in both single seal and double seal configurations. For example, for gap height H (exaggerated in FIG. 12B for purposes of illustration) and gap length L a given velocity of sweep gas flow V may result in isolation such that a concentration C2 of contaminant in the oven may be isolated with respect to the gas flow channel to the degree Cgap/C2=exp(−Pe), where Pe=VL/D, D is the diffusion constant of the contaminant in the sweep gas, and Cgap is the concentration of contaminant that develops within the gas flow seal channel. In at least some embodiments, it may be beneficial to ensure that gap height H may be significantly lower as compared to the gap length L (e.g., by at least a factor of ten). In some embodiments, where the gap height is not sufficiently uniform, and/or constant, channel 184 may be filled with an optional porous material 194, as shown in FIG. 12B to provide for flow impedance much greater than the flow impedance of the gap but still low enough to allow for the desired flow of sweep gas 192. For example, a porous material 194 may include a porous metal, having, for example, a porosity of about 0.001 Darcy to about 0.0001 Darcy, may be infilled into channel 184. For purposes of illustration, porous material 194 is illustrated as leaving gaps within channel 184. As understood, porous material 194 may be sized so as to substantially fill channel 184.

It is to be noted that all features of each debinding oven in the present disclosure may be combined with all features of each sintering furnace in the present disclosure. Additionally, any and all features of the debinding and sintering furnaces described herein, may be combined with all the features of the gate valves disclosed herein.

Embodiments of the present disclosure also include a method of operating a low-power powder metal sintering system 40, the system including: a sealable sintering furnace 42 having walls 44 covered inwardly by a sintering insulation layer 46, an inward face of the sintering insulation layer 46 defining a sintering hot zone volume 50; a sealable debinding oven 52 including a debinding hot zone volume 54; the sealable sintering furnace 42 having a controllably actuable gate valve 56, the gate valve 56 being arranged to: in an open position allow moving a shelf structure 58, that is capable of holding a part 30, from said debinding hot zone volume 54 to said sintering hot zone volume 50 and reciprocally; and in a closed position, restrict gaseous communication between the outside and the inside of the sintering furnace 42; the sintering furnace 42 comprising a heating element 60 in the sintering hot zone volume 50, the sintering insulation layer 46 and said heating element 60 being arranged for bringing a part 30 arranged in said sintering hot zone volume 50 at a sintering temperature in excess of 900 degrees centigrade using no more than 8 kW steady state of holding power per cubic foot of said sintering hot zone volume 50; and the debinding oven 52 being arranged for bringing a part 30 arranged in said debinding hot zone volume 54 at a debinding temperature in excess of 100 degrees centigrade, the debinding oven 52 having a sealable opening arranged for: in an open position, allowing to load from the outside of the system 40 a part 30 on the shelf structure 58 when the shelf structure is held outside said sintering hot zone volume 50; and in a closed position, restricting gaseous communication between the outside and the inside of the debinding oven 52; wherein the gate valve 56 may be in the closed position when the sealable opening is in the open position, such that the debinding oven 52 may operate as a load lock chamber for isolating the sintering furnace 42 from exposure to atmospheric contaminants; the method including: maintaining the sintering furnace 42 at a sintering pressure within a predetermined range of low pressures, and at one of the sintering temperature and a sintering furnace idle temperature, and using the debinding oven 52 as a load lock to the sintering furnace 42 with the sintering furnace 42 at the sintering furnace idle temperature.

In exemplary embodiments, using the debinding oven 52 as a load lock to the sintering furnace 42 with the sintering furnace at the sintering furnace idle temperature may include: with the gate valve 56 in the closed position and the shelf structure arrangement 58 in the debinding hot zone volume 54, opening the sealable opening of the debinding oven 52, loading from the outside of the system a part 30 on the shelf structure 58 and closing the sealable opening of the debinding oven 52; pumping down the debinding oven 52 and raising the temperature of the debinding oven 52 to the debinding temperature while maintaining a desired profile of pressure for a predetermined debinding time in the debinding oven 52; cleaning the debinding oven atmosphere from contaminants; opening the gate valve 56, moving the shelf structure 58 from the debinding hot zone volume 54 to the sintering hot zone volume 50, and closing the gate valve 56.

In exemplary embodiments, moving the shelf structure 58 from the debinding hot zone volume 54 to the sintering hot zone volume 50 may include: with an actuator 102 located out of the sintering furnace 42, moving a lock portion 100 controllably engaged with the shelf structure 58 from the debinding hot zone volume 54 to the sintering hot zone volume 52 until the shelf structure 58 rests on a predetermined seat 104; disengaging the lock portion 100 from the shelf structure 58; and moving the lock portion 100 out of the sintering hot zone volume such that the gate valve may be brought to the closed position.

In exemplary embodiments, the method may further include preventing (e.g., prohibiting) the opening of the gate valve 56 if the temperature inside the sintering furnace 42 is not sufficient for preventing the condensation of pollutants in the sintering furnace 42.

In exemplary embodiments the method may further include preventing the opening of the gate valve 56 prior to flushing the debinding oven at a temperature sufficient for preventing the condensation of pollutants in the debinding oven.

Having now described various embodiments in accordance with the requirements of the patent statutes, those skilled in this art will understand how to make changes and modifications to the disclosed systems and methods to meet their specific requirements or conditions. Such changes and modifications may be made without departing from the scope and spirit of the disclosure.

The foregoing detailed description of exemplary embodiments is presented for purposes of illustration and disclosure in accordance with the requirements of the law. It is not intended to be exhaustive nor limiting to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made the present disclosure with respect to the current state of the art, but also contemplates advancements and that adaptations in the future may take into consideration of those advancements, namely in accordance with the current state of the art. It is intended that the scope of the invention be defined by the claims as written and equivalents as applicable. Reference to a claim element in the singular is not intended to mean “one and only one” unless explicitly so stated.

What is claimed is:

1. A sintering and debinding system, comprising:
a debinding chamber configured to switch between an open state and a closed state, the open state being configured to permit receipt or removal of at least one part within or from the debinding chamber;
a sintering chamber operably connected to the debinding chamber and being vertically positioned above or below the debinding chamber;
a shelf structure configured to receive the at least one part, the shelf structure being movable between the debinding chamber and the sintering chamber; and
a gate valve configured to switch between an open state and a closed state, the gate valve being configured to selectively permit or block fluid communication between the debinding chamber and the sintering chamber, the gate valve being configured such that:
when the gate valve is in the open state, fluid communication between the debinding chamber and the sintering chamber is permitted and the shelf structure is movable between the debinding chamber and the sintering chamber, and
when the gate valve is in the closed state, fluid communication between the debinding chamber and the sintering chamber is restricted, and at least one of: (i) movement of the shelf structure between the debinding chamber and the sintering chamber is restricted or (ii) the debinding chamber is configured to permit receipt within and removal of the at least one part from the debinding chamber.

2. The system of claim 1, wherein the gate valve is configured to be in the closed state when generating heat during a debinding process so as to prevent communication of at least one of volatized binder from the at least one part or moisture from entering the sintering chamber such that, at the conclusion of the debinding process, a greater amount of volatized debinder is present in the debinding chamber as compared to the sintering chamber.

3. The system of claim 1, wherein when the gate valve is in the closed state, the debinding chamber is configured to be cleaned by heating an interior of the debinding chamber to a temperature of about 900 degrees centigrade or less.

4. The system of claim 1, wherein when the gate valve is in a closed state, the debinding chamber is configured to thermally debind the at least one part by heating an interior of the debinding chamber to a temperature of about 900 degrees centigrade or less.

5. The system of claim 1, wherein when the gate valve is in a closed state, the sintering chamber is configured to the at least one part to a temperature greater than about 1,000 degrees centigrade.

6. The system of claim 1, further comprising:
a cable configured to move the shelf structure between the debinding chamber and the sintering chamber.

7. The system of claim 6, wherein an end of the cable includes an enlarged end portion configured to be received by the shelf structure.

8. The system of claim 1, further comprising a loading gate configured to selectively permit access to the interior of the debinding chamber.

9. The system of claim 1, wherein the debinding chamber and the sintering chamber are connected to each other by a shared housing.

10. The system of claim 1, wherein the gate valve further comprises at least one curved plate.

11. The system of claim 10, wherein the at least one curved plate is movably positioned between the debinding chamber and the sintering chamber.

12. A sintering and debinding method, comprising:
placing at least one part inside a debinding chamber, wherein the debinding chamber is operably connected to a sintering chamber;
debinding the at least one part by raising a temperature within the debinding chamber to a debinding temperature while sealing the sintering chamber from the debinding chamber;
transferring the at least one part from the debinding chamber to the sintering chamber while fluid communication is permitted between the sintering chamber and the debinding chamber; and
sintering the at least one part within the sintering chamber.

13. The method of claim 12, wherein debinding includes closing a gate valve to seal the sintering chamber from the debinding chamber.

14. The method of claim 12, further including, after debinding, opening a gate valve to permit fluid communication between the sintering chamber and the debinding chamber.

15. The method of claim 12, further including moving a curved plate of a gate valve to either: (i) close the gate valve to seal the sintering chamber from the debinding chamber, or (ii) open the gate valve to permit fluid communication between the sintering chamber and the debinding chamber.

16. The method of claim 12, further including heating an interior of the debinding chamber to a temperature of about 900 degrees centigrade, or less.

17. The method of claim 16, further including heating an interior of the sintering chamber to a temperature greater than about 1,000 degrees centigrade.

18. The method of claim 17, further including transferring the at least one part from the debinding chamber to the sintering chamber after heating the interior of the debinding chamber and before heating the interior of the sintering chamber without removing the at least one part from a common housing of the debinding chamber and the sintering chamber.

19. A sintering and debinding system, comprising:
a debinding chamber including a loading gate configured to switch between an open state and a closed state, the open state of the loading gate being configured to permit receipt or removal of at least one part from within the debinding chamber;
a sintering chamber connected to the debinding chamber and positioned adjacent to the debinding chamber; and
a gate valve configured to switch between an open state and a closed state, the gate valve being configured to regulate fluid communication between the debinding chamber and the sintering chamber, the gate valve configured such that:
when the gate valve is in the open state, fluid communication is allowed between the debinding chamber and the sintering chamber and the at least one part is movable between the debinding chamber and the sintering chamber, and the loading gate is in the closed state, and
when the gate valve is in the closed state in which fluid communication between the debinding chamber and the sintering chamber is restricted, at least one of: (i) movement of the at least one part between the debinding chamber and the sintering chamber is restricted or (ii) the loading gate is in the open position enabling receipt and removal of the at least one part from the debinding chamber.

20. The system of claim 1, wherein the gate valve is configured to be closed during a debinding process so as to prevent communication of at least one of volatized binder from the at least one part or moisture from entering the sintering chamber such that, at the conclusion of the debinding process, a greater amount of volatized debinder is present in the debinding chamber as compared to the sintering chamber.
